(19) United States
(12) Patent Application Publication
(10) Pub. No.: US 2024/0302496 A1
(43) Pub. Date: Sep. 12, 2024

(54) PERSON DETECTION DEVICE, PERSON DETECTION SYSTEM, AND PERSON DETECTION METHOD

(71) Applicant: NEC CORPORATION, Minato, Tokyo (JP)

(72) Inventor: Katsuhiro Yutani, Tokyo (JP)

(73) Assignee: NEC CORPORATION, Minato-ku, Tokyo (JP)

(21) Appl. No.: 18/275,991

(22) PCT Filed: Feb. 17, 2021
(86) PCT No.: PCT/JP2021/005958

§ 371 Date: Aug. 4, 2023

(51) Int. Cl. G01S 7/48; G01S 17/89; G08B 21/24

(52) U.S. Cl. CPC G01S 7/4802; G01S 17/89; G08B 21/24

(57) ABSTRACT

A person detection device is provided with: a three-dimensional model generator which generates a three-dimensional model of a restricted area located in an area where water is discharged from a dam and in the surrounding area, on the basis of reflected light resulting from illumination of the restricted area with laser light; and a person detector which detects a person in the restricted area using the three-dimensional model.

### TECHNICAL FIELD

The present disclosure relates to a person detection device and the like.

### BACKGROUND ART

PTL 1 discloses a technique of monitoring another object (including a person and a non-human object) approaching a specific object in an area being a monitoring target, by light detection and ranging (LiDAR). Specifically, in the technique described in PTL 1, LiDAR is used for generating, in time series, distance images associated with the area. A plurality of the generated distance images are used for detecting motion of individual objects in the area. Based on a result of the detection, the another object approaching as described above is detected (see Abstract, paragraphs to [0010], [0043], and the like of PTL 1).

A technique described in PTL 2 is also known as a related art.

### CITATION LIST

### Patent Literature

PT1: Japanese Unexamined Patent Application Publication No. 2019-201268
PTL2: Japanese Unexamined Patent Application Publication No. 2019-168985

### SUMMARY OF INVENTION

### Technical Problem

As described above, the technique described in PTL 1 is for detecting motion of an object. In other words, the technique described in PTL 1 is for detecting a moving object without distinction between a person and a non-human object.

For example, it is assumed that safety confirmation is performed with respect to a person when water is discharged from a dam. In such a case, it is desired that, with respect to an area where water is discharged from the dam (hereinafter, referred to as a “water discharge area” in some cases), all persons being present in the water discharge area be detected. Further, it is desired that, among areas in the periphery of the water discharge area, with respect to an area where a person is exposed to danger at a time of water discharge (hereinafter, referred to as a “dangerous area” in some cases), all persons being present in the dangerous area be detected. Hereinafter, the water discharge area and the dangerous area are collectively referred to as a “restricted area” in some cases.

Specifically, when a person is present in the restricted area, it is suitable that the person be detected accurately whether the person is still or moving. However, when the technique described in PTL 1 is used, a moving object is detected without distinction between a person and a non-human object. Thus, there is a problem that it is difficult to accurately detect a person being present in the restricted area.

The present disclosure has been made in order to solve the above-mentioned problem, and an object thereof is to provide a person detection device and the like capable of accurately detecting a person being present in a restricted area.

### Solution to Problem

One aspect of a person detection device according to the present disclosure includes: a three-dimensional model generation means for generating, in an area where water of a dam is discharged and an area in a periphery thereof, a three-dimensional model of a restricted area, based on reflected light associated with laser light with which the restricted area is irradiated; and a person detection means for detecting a person in the restricted area by using the three-dimensional model.

One aspect of a person detection system according to the present disclosure includes: a three-dimensional model generation means for generating, in an area where water of a dam is discharged and an area in a periphery thereof, a three-dimensional model of a restricted area, based on reflected light associated with laser light with which the restricted area is irradiated; and a person detection means for detecting a person in the restricted area by using the three-dimensional model.

One aspect of a person detection method according to the present disclosure includes: generating, in an area where water of a dam is discharged and an area in a periphery thereof, a three-dimensional model of a restricted area by a three-dimensional model generation means, based on reflected light associated with laser light with which the restricted area is irradiated; and detecting a person in the restricted area by a person detection means by using the three-dimensional model.

### Advantageous Effects of Invention

According to the present disclosure, a person being present in a restricted area is able to be detected accurately.

### BRIEF DESCRIPTION OF DRAWINGS

FIG. 1 is a block diagram illustrating main parts of a person detection system according to a first example embodiment.

FIG. 2 is a block diagram illustrating main parts of an optical sensing device in the person detection system according to the first example embodiment.

FIG. 3 is a block diagram illustrating main parts of a person detection device according to the first example embodiment.

FIG. 4 is a block diagram illustrating a hardware configuration of the main parts of the person detection device according to the first example embodiment.

FIG. 5 is a block diagram illustrating another hardware configuration of the main parts of the person detection device according to the first example embodiment.

FIG. 6 is a block diagram illustrating another hardware configuration of the main parts of the person detection device according to the first example embodiment.

FIG. 7 is a flowchart illustrating an operation of the person detection device according to the first example embodiment.

FIG. 8 is an explanatory diagram illustrating specific examples of a restricted area and the like.

FIG. 9 is a block diagram illustrating main parts of another person detection system according to the first example embodiment.

FIG. 10 is a block diagram illustrating main parts of another person detection device according to the first example embodiment.

FIG. 11 is a block diagram illustrating main parts of a person detection system according to a second example embodiment.

FIG. 12 is a block diagram illustrating main parts of a person detection device according to the second example embodiment.

FIG. 13 is a flowchart illustrating an operation of the person detection device according to the second example embodiment.

### EXAMPLE EMBODIMENT

With reference to the attached drawings, example embodiments of the present disclosure are described below in detail.

### First Example Embodiment

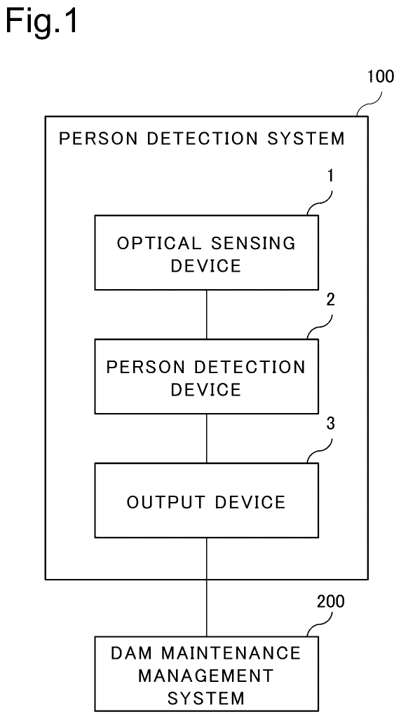

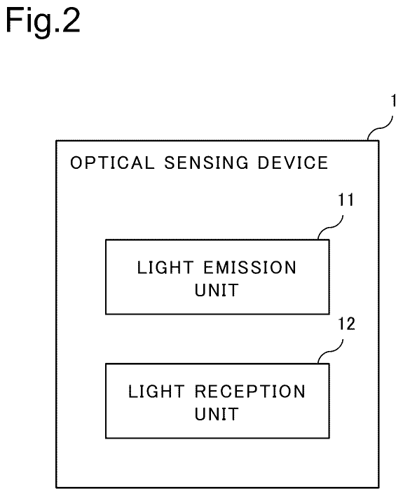

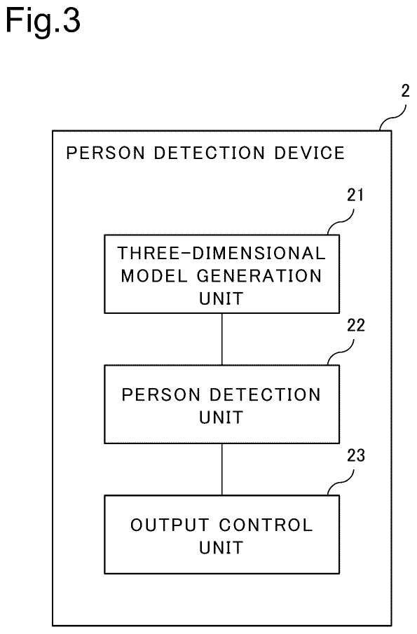

FIG. 1 is a block diagram illustrating main parts of a person detection system according to a first example embodiment. FIG. 2 is a block diagram illustrating main parts of an optical sensing device in the person detection system according to the first example embodiment. FIG. 3 is a block diagram illustrating main parts of a person detection device according to the first example embodiment. With reference to FIGS. 1 to 3, the person detection system according to the first example embodiment is described.

As illustrated in FIG. 1, a person detection system 100 includes an optical sensing device 1, a person detection device 2, and an output device 3. As illustrated in FIG. 2, the optical sensing device 1 includes a light emission unit 11 and a light reception unit 12. As illustrated in FIG. 3, the person detection device 2 includes a three-dimensional model generation unit 21, a person detection unit 22, and an output control unit 23.

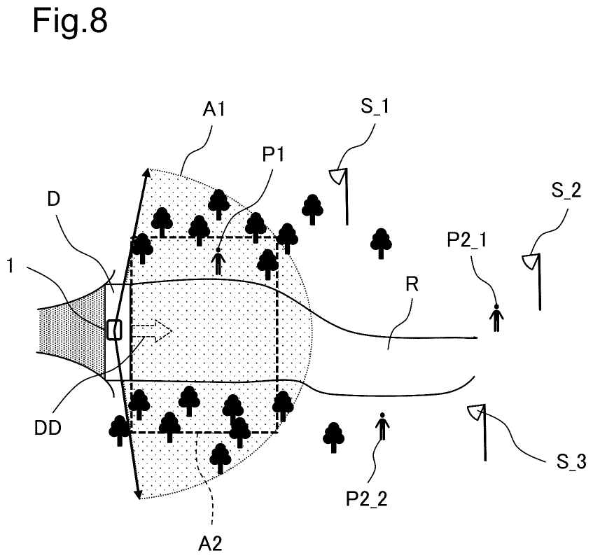

The optical sensing device 1 is installed inside a restricted area or in a periphery of the restricted area. Herein, as described above, the restricted area may include a water discharge area, and may also include a prohibited area. The water discharge area is an area where water of a dam is discharged. Among areas in the periphery of the water discharge area, a dangerous area is an area where a person is exposed to dangers. A specific example of the restricted area is described later with reference to FIG. 8.

For example, the light emission unit 11 is configured by using a laser light source. The light emission unit 11 emits pulsed laser light. Herein, in the optical sensing device 1, an emission direction of the laser light from the light emission unit 11 can be changed. With this, the light emission unit 11 emits the laser light sequentially in a plurality of directions. As a result, irradiation is performed with the laser light in such a way as to scan the restricted area.

The laser light with which irradiation is performed is reflected as scattered light by an object (including a person) in the restricted area. Hereinafter, the light being reflected is referred to as “reflected light” in some cases. The light reception unit 12 receives the reflected light. For example, the light reception unit 12 is configured by using a photodetector.

The three-dimensional model generation unit 21 generates a three-dimensional model of the restricted area, based on the laser light emitted by the light emission unit 11 and the reflected light received by the light reception unit 12. More specifically, the three-dimensional model generation unit 21 generates a three-dimensional point cloud model associated with a shape of each object in the restricted area. For generation of the three-dimensional model, the principle of time-of-flight (ToF) LiDAR is used.

Specifically, the three-dimensional model generation unit 21 acquires information indicating a timing at which the laser light is emitted in each of the directions and information indicating timing at which the reflected light being associated with the laser light is received. Such pieces of information are acquired from the optical sensing device 1, for example. By using such pieces of information, the three-dimensional model generation unit 21 calculates a one-way propagation distance associated with a round propagation time for the laser light being emitted in each of the directions and the reflected light being associated with the laser light.

The three-dimensional model generation unit 21 calculates a coordinate value indicating a location of a point at which the laser light emitted in each of the directions is reflected, based on the calculated one-way propagation distance. The coordinate value is a coordinate value in a virtual three-dimensional coordinate space. A point associated with each coordinate value is arranged in the three-dimensional coordinate space, and thus a three-dimensional point cloud model associated with a shape of each object in the restricted area is generated. In this manner, the three-dimensional model is generated.

In addition, various techniques that are publicly known may be used for generation of the three-dimensional model, based on the principle of ToF LiDAR. Detailed description for such techniques is omitted.

The person detection unit 22 detects a person being present in the restricted area by using the three-dimensional model generated by the three-dimensional model generation unit 21. More specifically, the person detection unit 22 detects a person being present in the restricted area by using the generated three-dimensional model to determine whether each object present in the restricted area is a person.

Specifically, as described above, the three-dimensional model generated by the three-dimensional model generation unit 21 includes a three-dimensional point cloud model associated with a shape of each object present in the restricted area. Herein, in the person detection unit 22, information indicating a general human shape (hereinafter, referred to as a “reference shape”) (hereinafter, referred to as “reference shape information”) is stored in advance. Alternatively, the person detection unit 22 acquires the reference shape information. The reference shape information may include information indicating a plurality of reference shapes associated with postures different from one another. Further, the reference shape information may include information indicating a plurality of reference shapes associated with sight directions different from one another. Further, the reference shape information may include information indicating a plurality of reference shapes associated with body shapes different from one another.

The person detection unit 22 compares a shape of each object present in the restricted area with each of the reference shapes, by using the generated three-dimensional model and the stored reference shape information or the acquired reference shape information. The person detection unit 22 determines whether each object is a person by so-called “pattern matching”. Specifically, for example, the person detection unit 22 calculates a difference between the shape of each object and each of the reference shapes. When the calculated difference relating to at least one of the reference shapes falls within a predetermined range, the person detection unit 22 determines that the object is a person. Otherwise, the person detection unit 22 determines that the object is not a person. In this manner, a person being present in the restricted area is detected.

The output control unit 23 executes control for outputting information based on the detection result by the person detection unit 22 (hereinafter, referred to as “detection result information”). For example, the detection result information may include information indicating presence or absence of a person in the restricted area and information indicating a location of a person in the restricted area. In other words, the detection result information may include information relating to a person detected by the person detection unit 22.

The detection result information is output by using the output device 3. For example, the output device 3 includes at least one of a display device, a sound output device, and a communication device. The display device is configured by using a display screen, for example. The sound output device is configured by using a speaker, for example. The communication device is configured by using a dedicated transmitter and a dedicated receiver, for example.

Specifically, for example, the output control unit 23 executes control for displaying an image associated with the detection result information. The image is displayed by using the display device in the output device 3. Herein, the image may include the three-dimensional model generated by the three-dimensional model generation unit 21. Alternatively, for example, the output control unit 23 executes control for outputting a sound associated with the detection result information. The sound is output by using the sound output device in the output device 3. Alternatively, for example, the output control unit 23 executes control for transmitting a signal associated with the detection result information. The signal is transmitted by using the communication device in the output device 3.

Herein, the signal may be transmitted to a dam maintenance management system 200 (see FIG. 1). In other words, the detection result information may be output to the dam maintenance management system 200. The dam maintenance management system 200 is a system that performs maintenance and management for the dam. As illustrated in FIG. 1, the dam maintenance management system 200 is provided outside of the person detection system 100. Hereinafter, the dam maintenance management system 200 is referred to as an “external dam maintenance system” in some cases. The output detection result information is used by the dam maintenance management system 200 for maintenance and management for the dam. Specifically, for example, the output detection result information is used by the dam maintenance management system 200 for a notice of warning for a person being present in the restricted area.

Specifically, when the detection result information indicates presence of a person in the restricted area, the dam maintenance management system 200 issues the notice of warning to the person by using a speaker installed in the periphery of the restricted area. Alternatively, in this case, the dam maintenance management system 200 instructs another person (for example, an operator of the dam maintenance management system 200) to issue the notice of warning. With this, a person being present in the restricted area can be prompted to evacuate. Note that, the information being output from by the output device 3 to the dam maintenance management system 200 is not limited to the detection result information (specifically, information relating to the detected person). For example, the output information may include information relating to the restricted area and information used for control for issuing the notice of warning, in addition to the detection result information.

In this manner, the main parts of the person detection system 100 are configured.

Hereinafter, the light emission unit 11 is referred to as a “light emission means” in some cases. Further, the light reception unit 12 is referred to as a “light reception means” in some cases. Further, the three-dimensional model generation unit 21 is referred to as a “three-dimensional model generation means” in some cases. Further, the person detection unit 22 is referred to as a “person detection means” in some cases. Further, the output control unit 23 is referred to as an “output control means” in some cases.

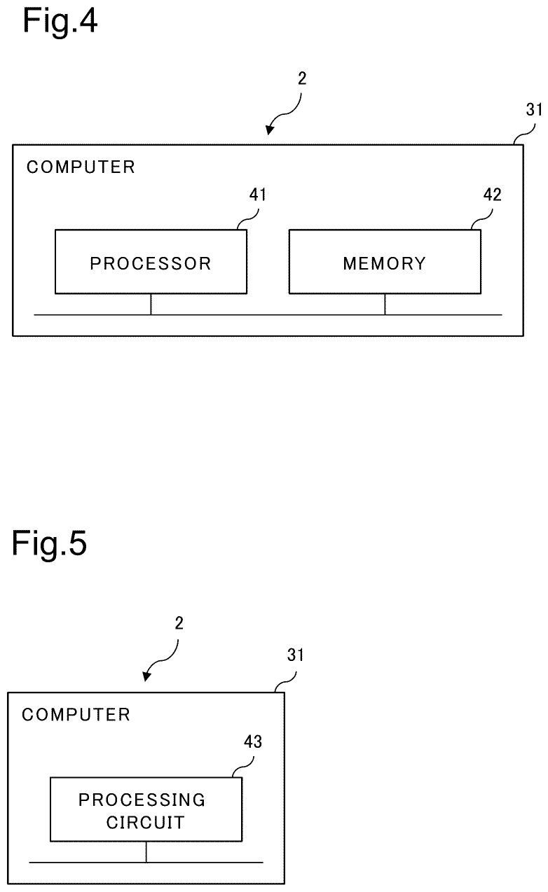

Next, with reference to FIGS. 4 to 6, a hardware configuration of main parts of the person detection device 2 is described.

As illustrated in each of FIGS. 4 to 6, the person detection device 2 is configured by using a computer 31. The computer 31 may be provided integrally with the optical sensing device 1. Alternatively, the computer 31 may be provided at another location (for example, within a cloud network). Alternatively, some elements of the computer 31 are provided integrally with the optical sensing device 1, and the remaining elements of the computer 31 may be provided at another location.

As illustrated in FIG. 4, the computer 31 includes a processor 41 and a memory 42. The memory 42 stores a program for causing the computer 31 to function as the three-dimensional model generation unit 21, the person detection unit 22, and the output control unit 23. The processor 41 reads out and executes the program stored in the memory 42. With this, a function F1 of the three-dimensional model generation unit 21, a function F2 of the person detection unit 22, and a function F3 of the output control unit 23 are achieved.

Alternatively, as illustrated in FIG. 5, the computer 31 includes a processing circuit 43. The processing circuit 43 executes processing for causing the computer 31 to function as the three-dimensional model generation unit 21, the person detection unit 22, and the output control unit 23. With this, the functions F1 to F3 are achieved.

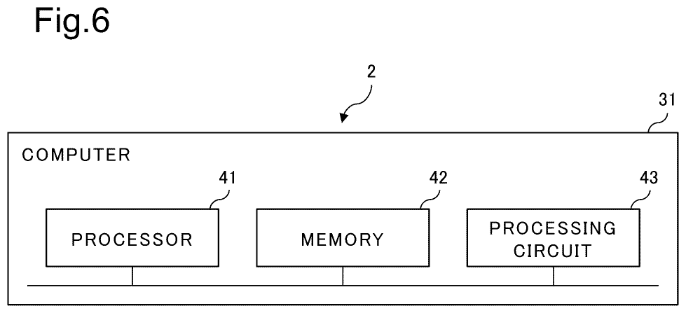

Alternatively, as illustrated in FIG. 6, the computer 31 includes the processor 41, the memory 42, and the processing circuit 43. In this case, some functions of the functions F1 to F3 are achieved by the processor 41 and the memory 42, and the remaining functions of the functions F1 to F3 are achieved by the processing circuit 43.

The processor 41 is configured by one or more processors. For example, each processor is configured by using a central processing unit (CPU), a graphics processing unit (GPU), a microprocessor, a microcontroller, or a digital signal processor (DSP).

The memory 42 is configured by one or more memories. For example, each memory is configured by using a random-access memory (RAM), a read-only memory (ROM), a flash memory, an erasable programmable read-only memory (EPROM), an electrically erasable programmable read-only memory (EEPROM), a solid-state drive, a hard disk drive, a flexible disk, a compact disc, a digital versatile disc (DVD), a Blu-ray disc, a magneto-optical (MO) disc, or a mini disc.

The processing circuit 43 is configured by one or more processing circuits. For example, each processing circuit is configured by using an application specific integrated circuit (ASIC), a programmable logic device (PLD), a field programmable gate array (FPGA), a system on a chip (SoC), or a system large scale integration (LSI).

The processor 41 may include a dedicated processor for each of the functions F1 to F3. The memory 42 may include a dedicated memory for each of the functions F1 to F3. The processing circuit 43 may include a dedicated processing circuit for each of the functions F1 to F3.

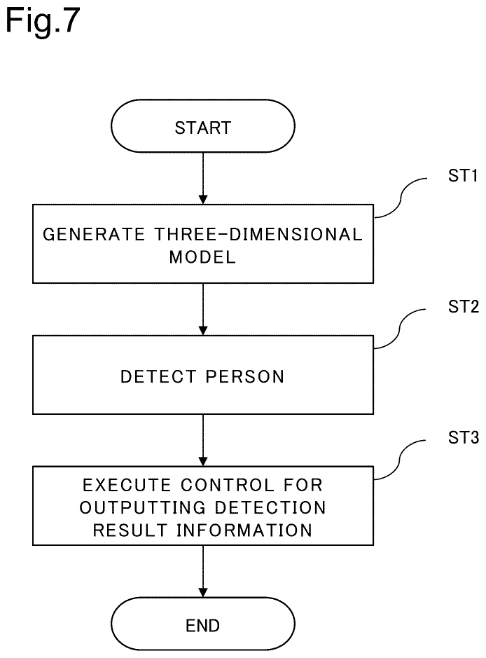

Next, with reference to the flowchart illustrated in FIG. 7, an operation of the person detection device 2 is described.

First, the three-dimensional model generation unit 21 generates the three-dimensional model of the restricted area (step ST1). As described above, the three-dimensional model is generated by using the technique of TOF LIDAR. Subsequently, the person detection unit 22 detects a person being present in the restricted area (step ST2). As described above, the three-dimensional model generated in step ST1 is used for the detection. Subsequently, the output control unit 23 executes control for outputting the information based on the detection result in step ST2 (specifically, the detection result information) (step ST3).

Next, with reference to FIG. 8, a specific example of the restricted area is described.

In the drawing, D indicates a dam. The dam D may be a hydroelectric dam. In the drawing, R indicates a river located downstream of the dam D. In the drawing, DD indicates an example of a water discharge direction from the dam D to the river R. In the example illustrated in FIG. 8, the optical sensing device 1 is installed at a position in the vicinity of an overflow (a so called “spillway” or a drain) of the dam D.

In the drawing, A1 indicates a range downstream of the dam D. Herein, as illustrated in FIG. 8, the shape of the range A1 is a fan shape. The center position of the fan shape corresponds to the installation position of the optical sensing device 1. The central angle of the fan shape is set to a predetermined value (for example, approximately 180 degrees). The radius of the fan shape is set to a predetermined value (for example, 300 meters). Specifically, the range A1 is associated with a range that can be irradiated by the optical sensing device 1 with the laser light.

In the drawing, A2 indicates a rectangular range inscribed inside the fan shape of the range A1. As illustrated in FIG. 8, the range A2 includes a part of the river R and a part of the bank (more specifically, both the banks) of the river R.

In the example illustrated in FIG. 8, the range A2 is set as the restricted area. Specifically, in this case, the part of the river R being included in the range A2 is the water discharge area. Further, the part of the bank (more specifically, both the banks) of the river R being included in the range A2 is the dangerous area.

In the drawing, P1 indicates a person being present in the restricted area. As described above, the detection result information may be used for the notice of warning being issued to the person P1 by the dam maintenance management system 200. In the drawing, each of S_1, S_2, and S_3 indicates a speaker used for the notice of warning. In the drawing, each of P2_1 and P2_2 indicates another person who gives the notice of warning under an instruction from the dam maintenance management system 200.

Note that, the restricted area is not limited to the example illustrated in FIG. 8. For example, when the radius of the fan shape of the range A1 has a large value (for example, a value greater than 500 meters) or the length of the river R is short, the range A2 inscribed inside the range A1 may include an estuary of the river R. With this, the range A2 may include a coastal strip in the periphery of the estuary. In this case, the coastal strip may be included in the dangerous area.

Next, effects exerted by using the person detection system 100 are described.

As described above, for each object present in the restricted area, the three-dimensional model of the restricted area is generated, and thus it can be determined whether each object is a person by pattern matching based on the shape. Thus, when each object is a person, a person can be detected regardless of the person being still or moving, based on the shape of the person at a timing when irradiation is performed with the laser light. Specifically, a person present in the restricted area can be detected regardless of the person being still or moving. In other words, the person can be detected accurately.

Next, modification examples of the person detection system 100 are described.

The light emission unit 11 and the light reception unit 12 are provided to the optical sensing device 1, but may be provided to the person detection device 2 instead. Specifically, the person detection device 2 may include the light emission unit 11 and the light reception unit 12. In this case, the optical sensing device 1 is not required.

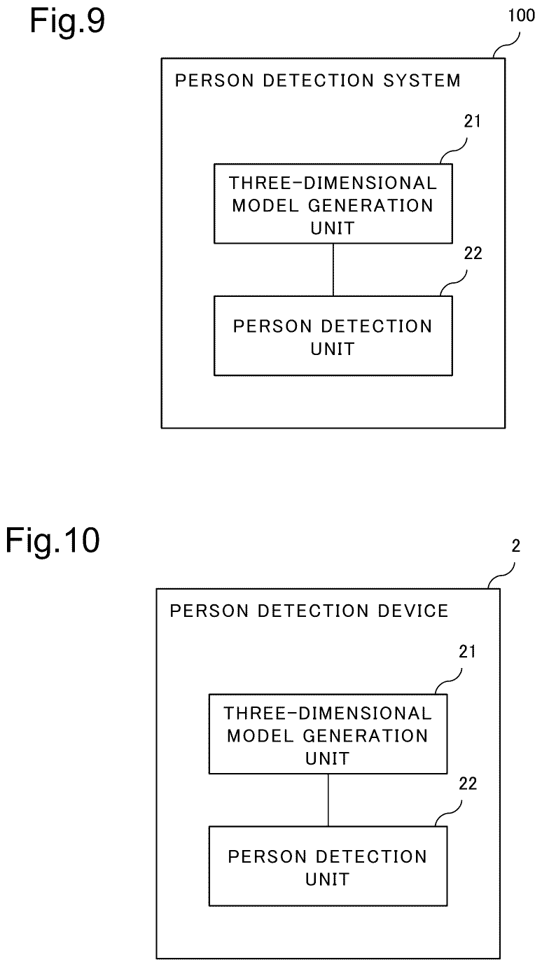

Next, with reference to FIG. 9, another modification example of the person detection system 100 is described. Further, with reference to FIG. 10, a modification example of the person detection device 2 is described.

As illustrated in FIG. 9, the person detection system 100 may include the three-dimensional model generation unit 21 and the person detection unit 22. In other words, the main parts of the person detection system 100 may be configured by the three-dimensional model generation unit 21 and the person detection unit 22. In this case, the optical sensing device 1 may be provided outside of the person detection system 100. Further, the output control unit 23 may be provided outside of the person detection system 100. Further, the output device 3 may be provided outside of the person detection system 100. In the person detection system 100, each of the three-dimensional model generation unit 21 and the person detection unit 22 may be configured by an independent device.

As illustrated in FIG. 10, the person detection device 2 may include the three-dimensional model generation unit 21 and the person detection unit 22. In other words, the main parts of the person detection device 2 may be configured by the three-dimensional model generation unit 21 and the person detection unit 22. In this case, the output control unit 23 may be provided outside of the person detection device 2.

In any one of such cases, the effects described above can be exerted. Specifically, the three-dimensional model generation unit 21 generates the three-dimensional model of the restricted area, based on the reflected light associated with the laser light with which the restricted area is irradiated. The person detection unit 22 detects a person in the restricted area by using the three-dimensional model. Herein, by using the three-dimensional model, it can be determined whether each object is a person by pattern matching based on the shape of each object being present in the restricted area. Thus, when each object is a person, the person can be detected regardless of the person being still or moving, based on the shape of the person at a timing when irradiation is performed with the laser light. In other words, a person being present in the restricted area can be detected, regardless of the person being still or moving. Specifically, the person can be detected accurately.

### Second Example Embodiment

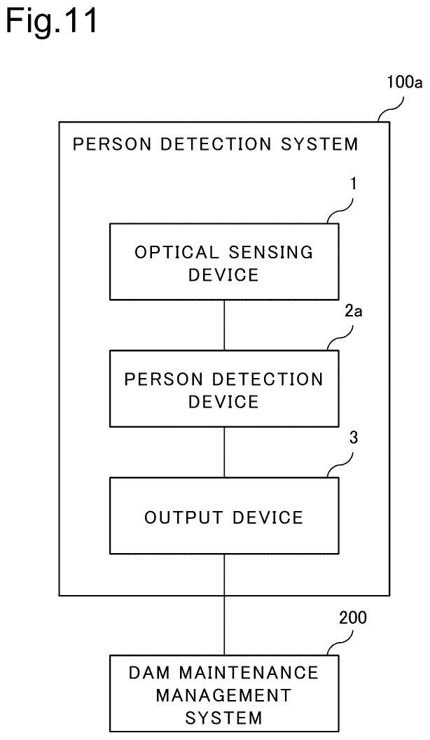

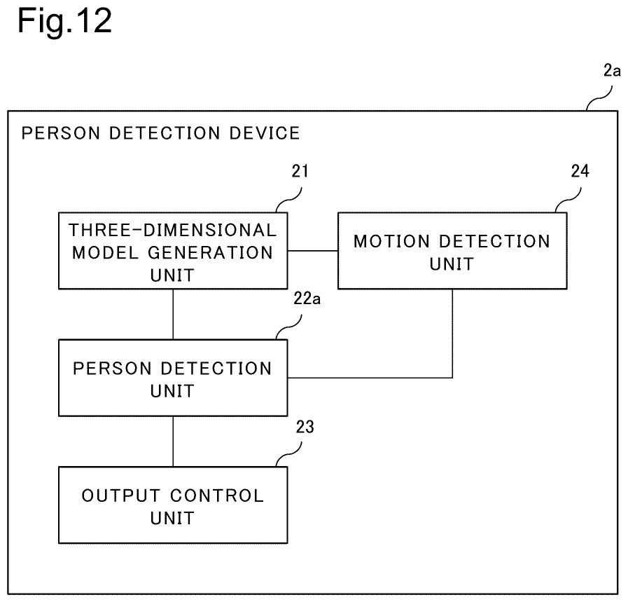

FIG. 11 is a block diagram illustrating main parts of a person detection system according to a second example embodiment. FIG. 12 is a block diagram illustrating main parts of a person detection device according to the second example embodiment. With reference to FIGS. 11 and 12, the person detection system according to the second example embodiment is described. Note that, in FIGS. 11 and 12 the blocks similar to the blocks illustrated in FIGS. 1 to 3 are denoted with the same reference signs, and description therefor is omitted.

As illustrated in FIG. 11, a person detection system 100a includes an optical sensing device 1, a person detection device 2a, and an output device 3. As illustrated in FIG. 12, the person detection device 2a includes a three-dimensional model generation unit 21, a person detection unit 22a, an output control unit 23, and a motion detection unit 24.

The motion detection unit 24 detects motion of each object present in a restricted area, based on laser light emitted by a light emission unit 11 and reflected light received by a light reception unit 12. For detection of the motion, the principle of Doppler LiDAR is used.

Specifically, as described in the first example embodiment, the three-dimensional model generated by the three-dimensional model generation unit 21 includes a three-dimensional point cloud model associated with a shape of each object present in the restricted area. For each point in the three-dimensional point cloud model, the motion detection unit 24 acquires information indicating a frequency component contained in the associated laser light and information indicating a frequency component contained in the associated reflected light. Such pieces of information are acquired from the optical sensing device 1, for example. By using such pieces of information, the motion detection unit 24 calculates a Doppler shift amount of the associated reflected light for each object. The Doppler shift amount has, as a reference, the frequency of the laser light emitted by the light emission unit 11. In other words, for each object, the Doppler shift amount is based on a difference between the frequency component contained in the laser light associated therewith and the frequency component contained in the reflected light associated therewith.

The motion detection unit 24 detects motion of each object present in the restricted area, based on the calculated Doppler shift amount. More specifically, the motion detection unit 24 detects orientation and velocity of the motion. With this, presence or absence of the motion is also detected. Various techniques that are publicly known may be used for detection of motion of an object based on the principle of Doppler LIDAR. Detailed description for those techniques is omitted.

For each object present in the restricted area, when the object is still, the person detection unit 22a determines whether the object is a person by a detection method similar to the detection method performed by the person detection unit 22. Specifically, the person detection unit 22a compares the shape of the object with the reference shape, and determines whether the object is a person by pattern matching. Meanwhile, when the object is moving, the person detection unit 22a determines whether the object is a person in the following manner.

Specifically, in the person detection unit 22a, information indicating a generally possible range for a person (hereinafter, referred to as a “reference range”) that relates to orientation and velocity of motion of a person in the restricted area (hereinafter, referred to as “reference range information”) is stored. Alternatively, the person detection unit 22a acquires the reference range information. The reference range information may include information including a plurality of reference ranges associated with locations different from one another in the restricted area.

For a moving object among the objects present in the restricted area, the person detection unit 22a determines whether the motion of the object is motion within the reference range, based on the detection result by the motion detection unit 24, by using the stored reference range information or the acquired reference range information. When the motion of the object is motion within the reference, the person detection unit 22a determines that the object is a person. Meanwhile, when the motion of the object is motion outside the reference range, the person detection unit 22a determines that the object is not a person. In this manner, a person being present in the restricted area is detected.

Alternatively, for the moving object among the objects present in the restricted area, the person detection unit 22a compares the shape of the object with the reference shape, and determines whether the motion of the object is motion within the reference range. When the difference between the shape of the object and the reference shape falls within the predetermined range, and the motion of the object is motion within the reference range, the person detection unit 22a determines that the object is a person. Otherwise, the person detection unit 22a determines that the object is not a person. In this manner, a person being present in the restricted area is detected.

In this manner, the main parts of the person detection system 100a are configured.

Hereinafter, the person detection unit 22a is referred to as a “person detection means” in some cases. Further, the motion detection unit 24 is referred to as a “motion detection means” in some cases.

A hardware configuration of main parts of the person detection device 2a is similar to that described in the first example embodiment with reference to FIGS. 4 to 6. Thus, detailed description therefor is omitted.

Specifically, a function F1 of the three-dimensional model generation unit 21, a function F2a of the person detection unit 22a, a function F3 of the output control unit 23, and a function F4 of the motion detection unit 24 may be achieved by a processor 41 and a memory 42. Alternatively, the functions F1, F2a, F3, and F4 may be achieved by a processing circuit 43.

Herein, the processor 41 may include a dedicated processor for each of the functions F1, F2a, F3, and F4. The memory 42 may include a dedicated memory for each of the functions F1, F2a, F3, and F4. The processing circuit 43 may include a dedicated processing circuit for each of the functions F1, F2a, F3, and F4.

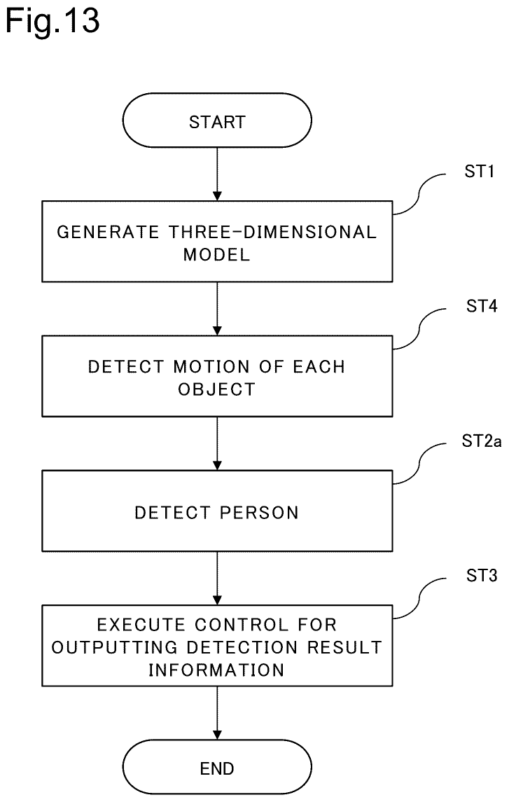

Next, with reference to the flowchart illustrated in FIG. 13, an operation of the person detection device 2a is described. Note that, in FIG. 13, steps similar to the steps illustrated in FIG. 7 are denoted with the same reference signs.

First, the three-dimensional model generation unit 21 generates the three-dimensional model of the restricted area (step ST1). As described in the first example embodiment, the technique of ToF LiDAR is used for generating the three-dimensional model. Subsequently, the motion detection unit 24 detects motion of each object present in the restricted area (step ST4). As described above, the technique of Doppler LiDAR is used for detecting the motion.

Subsequently, the person detection unit 22a detects a person being present in the restricted area (step ST2a). As described in the first example embodiment, the three-dimensional model generated in step ST1 is used for the detection. Further, as described above, the result of the motion detection in step ST4 is used for the detection. Subsequently, the output control unit 23 executes control for outputting the information based on the detection result in step ST2a (specifically, the detection result information) (step ST3).

Next, effects exerted by using the person detection system 100a are described.

As described above, for each object present in the restricted area, it can be determined whether the object is a person regardless of the object being still or moving, by using the person detection system 100a. Specifically, a person being present in the restricted area can be detected regardless of the person being still or moving. In other words, the person can be detected accurately.

In particular, in addition to determination based on a shape, determination based on motion is used for a moving object among the objects present in the restricted area, and thus accuracy of determination whether the object is a person can be improved. With this, accuracy of detecting a moving person can be improved.

Next, modification examples of the person detection system 100a are described.

The person detection system 100a may adopt various modification examples similar to those described in the first example embodiment.

For example, the light emission unit 11 and the light reception unit 12 are provided to the optical sensing device 1, but may be provided to the person detection device 2a instead. Specifically, the person detection device 2a may include the light emission unit 11 and the light reception unit 12.

Further, for example, the person detection system 100a may include the three-dimensional model generation unit 21, the person detection unit 22a, and the motion detection unit 24. In other words, the main parts of the person detection system 100a may be configured by the three-dimensional model generation unit 21, the person detection unit 22a, and the motion detection unit 24.

Further, for example, the person detection device 2a may include the three-dimensional model generation unit 21, the person detection unit 22a, and the motion detection unit 24. In other words, the main parts of the person detection device 2a may be configured by the three-dimensional model generation unit 21, the person detection unit 22a, and the motion detection unit 24.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

The whole or a part of the example embodiments described above can be described as, but not limited to, the following supplementary notes.

### (Supplementary Notes)

### (Supplementary Note 1)

A person detection device including:
a three-dimensional model generation means for generating, in an area where water of a dam is discharged and an area in a periphery of the area, a three-dimensional model of a restricted area, based on reflected light associated with laser light with which the restricted area is irradiated; and
a person detection means for detecting a person in the restricted area by using the three-dimensional model.

### (Supplementary Note 2)

The person detection device according to Supplementary Note 1, wherein the person detection means determines whether an object is the person, based on a shape of the object in the restricted area, by using the three-dimensional model, and thus detects the person.

### (Supplementary Note 3)

The person detection device according to Supplementary Note 2, wherein the person detection means determines whether the object is the person by comparing the shape of the object with a reference shape.

### (Supplementary Note 4)

The person detection device according to Supplementary Note 2 or 3, further including
a motion detection means for detecting motion of the object, based on a difference between a frequency component contained in the laser light and a frequency component contained in the reflected light, wherein
the person detection means determines whether the object is the person, based on the shape of the object and the motion of the object.

### (Supplementary Note 5)

The person detection device according to Supplementary Note 4, wherein the person detection means determines whether the object is the person, based on the shape of the object, when the object is still, and determines whether the object is the person, based on the motion of the object, when the object is moving.

### (Supplementary Note 6)

The person detection device according to Supplementary Note 4, wherein the person detection means determines whether the object is the person, based on the shape of the object, when the object is still, and determines whether the object is the person, based on the shape of the object and the motion of the object, when the object is moving.

### (Supplementary Note 7)

The person detection device according to any one of Supplementary Notes 1 to 6, further including
an output control means for outputting information relating to the person to an external dam maintenance system, wherein
the information is used for a notice of warning for the person.

### (Supplementary Note 8)

A person detection system including:
a three-dimensional model generation means for generating, in an area where water of a dam is discharged and an area in a periphery of the area, a three-dimensional model of a restricted area, based on reflected light associated with laser light with which the restricted area is irradiated; and
a person detection means for detecting a person in the restricted area by using the three-dimensional model.

### (Supplementary Note 9)

The person detection system according to Supplementary Note 8, wherein the person detection means determines whether an object is the person, based on a shape of the object in the restricted area, by using the three-dimensional model, and thus detects the person.

### (Supplementary Note 10)

The person detection system according to Supplementary Note 9, wherein the person detection means determines whether the object is the person by comparing the shape of the object with a reference shape.

### (Supplementary Note 11)

The person detection system according to Supplementary Note 9 or 10, further including
a motion detection means for detecting motion of the object, based on a difference between a frequency component contained in the laser light and a frequency component contained in the reflected light, wherein
the person detection means determines whether the object is the person, based on the shape of the object and the motion of the object.

### (Supplementary Note 12)

The person detection system according to Supplementary Note 11, wherein the person detection means determines whether the object is the person, based on the shape of the object, when the object is still, and determines whether the object is the person, based on the motion of the object, when the object is moving.

### (Supplementary Note 13)

The person detection system according to Supplementary Note 11, wherein the person detection means determines whether the object is the person, based on the shape of the object, when the object is still, and determines whether the object is the person, based on the shape of the object and the motion of the object, when the object is moving.

### (Supplementary Note 14)

The person detection system according to any one of Supplementary Notes 8 to 13, further including
an output control means for outputting information relating to the person to an external dam maintenance system, wherein
the information is used for a notice of warning for the person.

### (Supplementary Note 15)

A person detection method including:
generating, in an area where water of a dam is discharged and an area in a periphery of the area, a three-dimensional model of a restricted area by a three-dimensional model generation means, based on reflected light associated with laser light with which the restricted area is irradiated; and
detecting a person in the restricted area by a person detection means by using the three-dimensional model.

### (Supplementary Note 16)

The person detection method according to Supplementary Note 15, wherein the person detection means determines whether an object is the person, based on a shape of the object in the restricted area, by using the three-dimensional model, and thus detects the person.

### (Supplementary Note 17)

The person detection method according to Supplementary Note 16, wherein the person detection means determines whether the object is the person by comparing the shape of the object with a reference shape.

### (Supplementary Note 18)

The person detection method according to Supplementary Note 16 or 17, further including:
detecting motion of the object by a motion detection means, based on a difference between a frequency component contained in the laser light and a frequency component contained in the reflected light, wherein
the person detection means determines whether the object is the person, based on the shape of the object and the motion of the object.

### (Supplementary Note 19)

The person detection method according to Supplementary Note 18, wherein the person detection means determines whether the object is the person, based on the shape of the object, when the object is still, and determines whether the object is the person, based on the motion of the object, when the object is moving.

### (Supplementary Note 20)

The person detection method according to Supplementary Note 18, wherein the person detection means determines whether the object is the person, based on the shape of the object, when the object is still, and determines whether the object is the person, based on the shape of the object and the motion of the object, when the object is moving.

### (Supplementary Note 21)

The person detection method according to any one of Supplementary Notes 15 to 20, further including
outputting information relating to the person to an external dam maintenance system by an output control means, wherein
the information is used for a notice of warning for the person.

### (Supplementary Note 22)

A recording medium recording a program for causing a computer to function as:
a three-dimensional model generation means for generating, in an area where water of a dam is discharged and an area in a periphery of the area, a three-dimensional model of a restricted area, based on reflected light associated with laser light with which the restricted area is irradiated; and
a person detection means for detecting a person in the restricted area by using the three-dimensional model.

### (Supplementary Note 23)

The recording medium according to Supplementary Note 22, wherein the person detection means determines whether an object is the person, based on a shape of the object in the restricted area, by using the three-dimensional model, and thus detects the person.

### (Supplementary Note 24)

The recording medium according to Supplementary Note 23, wherein the person detection means determines whether the object is the person by comparing the shape of the object with a reference shape.

### (Supplementary Note 25)

The recording medium according to Supplementary Note 23 or 24, wherein
the program further causes the computer to function as a motion detection means for detecting motion of the object, based on a difference between a frequency component contained in the laser light and a frequency component contained in the reflected light, and
the person detection means determines whether the object is the person, based on the shape of the object and the motion of the object.

### (Supplementary Note 26)

The recording medium according to Supplementary Note 25, wherein the person detection means determines whether the object is the person, based on the shape of the object, when the object is still, and determines whether the object is the person, based on the motion of the object, when the object is moving.

### (Supplementary Note 27)

The recording medium according to Supplementary Note 25, wherein the person detection means determines whether the object is the person, based on the shape of the object, when the object is still, and determines whether the object is the person, based on the shape of the object and the motion of the object, when the object is moving.

### (Supplementary Note 28)

The recording medium according to any one of Supplementary
Notes 22 to 27, wherein the program further causes the computer to function as an output control means for outputting information relating to the person to an external dam maintenance system, and
the information is used for a notice of warning for the person.

### REFERENCE SIGNS LIST

1 Optical sensing device
2, 2a Person detection device
3 Output device
11 Light emission unit
12 Light reception unit
21 Three-dimensional model generation unit
22, 22a Person detection unit
23 Output control unit
24 Motion detection unit
31 Computer
41 Processor
42 Memory
43 Processing circuit
100, 100a Person detection system
200) Dam maintenance management system

What is claimed is:

1. A person detection device comprising:
a three-dimensional model generator configured to generate, in an area where water of a dam is discharged and an area in a periphery of the area, a three-dimensional model of a restricted area, based on reflected light associated with laser light with which the restricted area is irradiated; and
a person detector configured to detect a person in the restricted area by using the three-dimensional model.

2. The person detection device according to claim 1, wherein the person detector determines whether an object is the person, based on a shape of the object in the restricted area, by using the three-dimensional model, and thus detects the person.

3. The person detection device according to claim 2, wherein the person detector determines whether the object is the person by comparing the shape of the object with a reference shape.

4. The person detection device according to claim 2, further comprising a motion detector configured to detect motion of the object, based on a difference between a frequency component contained in the laser light and a frequency component contained in the reflected light, wherein
the person detector determines whether the object is the person, based on the shape of the object and the motion of the object.

5. The person detection device according to claim 4, wherein the person detector determines whether the object is the person, based on the shape of the object, when the object is still, and determines whether the object is the person, based on the motion of the object, when the object is moving.

6. The person detection device according to claim 4, wherein the person detector determines whether the object is the person, based on the shape of the object, when the object is still, and determines whether the object is the person, based on the shape of the object and the motion of the object, when the object is moving.

7. The person detection device according to claim 1, further comprising
an output controller configured to control information relating to the person to an external dam maintenance system, wherein the information is used for a notice of warning for the person.

8. A person detection system comprising:
a three-dimensional model generator configured to generate, in an area where water of a dam is discharged and an area in a periphery of the area, a three-dimensional model of a restricted area, based on reflected light associated with laser light with which the restricted area is irradiated; and
a person detector configured to detect a person in the restricted area by using the three-dimensional model.

9. The person detection system according to claim 8, wherein the person detector determines whether an object is the person, based on a shape of the object in the restricted area, by using the three-dimensional model, and thus detects the person.

10. The person detection system according to claim 9, wherein the person detector determines whether the object is the person by comparing the shape of the object with a reference shape.

11. The person detection system according to claim 9, further comprising
a motion detector configured to detect motion of the object, based on a difference between a frequency component contained in the laser light and a frequency component contained in the reflected light, wherein
the person detector determines whether the object is the person, based on the shape of the object and the motion of the object.

12. The person detection system according to claim 11, wherein the person detector determines whether the object is the person, based on the shape of the object, when the object is still, and determines whether the object is the person, based on the motion of the object, when the object is moving.

13. The person detection system according to claim 11, wherein the person detector determines whether the object is the person, based on the shape of the object, when the object is still, and determines whether the object is the person, based on the shape of the object and the motion of the object, when the object is moving.

14. The person detection system according to claim 8, further comprising
an output controller configured to output information relating to the person to an external dam maintenance system, wherein
the information is used for a notice of warning for the person.

15. A person detection method comprising:
generating, in an area where water of a dam is discharged and an area in a periphery of the area, a three-dimensional model of a restricted area by a three-dimensional model generator, based on reflected light associated with laser light with which the restricted area is irradiated; and
detecting a person in the restricted area by person detector by using the three-dimensional model.

16. The person detection method according to claim 15, wherein the person detector determines whether an object is the person, based on a shape of the object in the restricted area, by using the three-dimensional model, and thus detects the person.

17. The person detection method according to claim 16, wherein the person detector determines whether the object is the person by comparing the shape of the object with a reference shape.

18. The person detection method according to claim 16, further comprising
detecting motion of the object by a motion detector, based on a difference between a frequency component contained in the laser light and a frequency component contained in the reflected light, wherein
the person detector determines whether the object is the person, based on the shape of the object and the motion of the object.

19. The person detection method according to claim 18, wherein the person detector determines whether the object is the person, based on the shape of the object, when the object is still, and determines whether the object is the person, based on the motion of the object, when the object is moving.

20. The person detection method according to claim 18, wherein the person detector determines whether the object is the person, based on the shape of the object, when the object is still, and determines whether the object is the person, based on the shape of the object and the motion of the object, when the object is moving.

21. The person detection method according to claim 15, further comprising
outputting information relating to the person to an external dam maintenance system, by an output controller, wherein
the information is used for a notice of warning for the person.
